(19) United States
(12) Patent Application Publication
(10) Pub. No.: US 2020/0302414 A1
(43) Pub. Date: Sep. 24, 2020

(54) METHOD AND SYSTEM FOR MANAGING MULTIMEDIA CONTENTS POSTED THROUGH A SOCIAL NETWORK

(71) Applicant: Giovanni Pachera, Lazise (IT)

(72) Inventor: Giovanni Pachera, Lazise (IT)

(21) Appl. No.: 16/754,722

(22) PCT Filed: Oct. 9, 2018
(86) PCT No.: PCT/IB2018/057803

§ 371 Date: Apr. 8, 2020

(30) Foreign Application Priority Data
Oct. 12, 2017 (IT) 102017000115235

(51) Int. Cl. G06Q 20/12; G06Q 20/36; G06Q 50/00

(52) U.S. Cl. CPC G06Q 20/123; G06Q 50/01; G06Q 20/363

(57) ABSTRACT

A method for managing multimedia contents posted through a social network and wherein said method is implemented by means of a computer, comprising the steps of:
processing a multimedia content to blur it so as to generate a blurred copy of said multimedia content and a clean copy;
posting said blurred copy of said multimedia content on said social network;
receiving through said social network a predetermined exchange value and associated with said blurred copy of the multimedia content, from a second user;
accumulating said exchange value in a value wallet associated with the first user;
making said clean copy of the multimedia content visible only to said second user via said social network.

The present invention relates to a method and system for managing multimedia contents posted through a social network.

In particular, the present invention relates to the field of the social networks currently used or can relate to a new type of social network in its own right.

In detail, the present invention relates to the part of posting multimedia contents by users who have pre-registered on the social network.

Currently, in relation to known social networks such as Facebook ®, Instagram ®, . . . a user can load a “post” such as photos or videos or other contents by means of a device (usually a smartphone) on which an access portal is created.

Such contents are posted on a public wall visible to people who have also pre-registered on the same social network with whom a connection has been established (e.g. friendship).

The users with whom there is such a connection can also express a judgement of appreciation or can write a comment in relation to a photo or a video.

Parallel to the above, there are currently software applications (often intrinsic to the same social network) that allow statistics operations to be performed according to the judgements expressed in relation to a photo so as to determine the degree of curiosity aroused or the degree of originality and popularity.

However, the current statistical detection methods often have drawbacks connected with the fact that many pre-registered users who see the photo do not express any judgement although they appreciate what they see (in their heads).

In this situation, the object of the present invention is to realize a method and system for managing multimedia contents posted through a social network which obviates the above-cited drawbacks.

It is in particular an object of the present invention to realize a method and system for managing multimedia contents posted through a social network that allows the computation of judgements for multimedia contents to be expanded and optimized.

It is also an object of the present invention to realize a method and system for managing multimedia contents posted through a social network that allows the organization of the computations of judgements of multimedia contents to be optimized.

The indicated objects are substantially attained by a method and system for managing multimedia contents through a social network according to what is described in the appended claims.

Further characteristics and advantages of the present invention will more greatly emerge from the detailed description that follows of some preferred but not exclusive embodiments of a method and system for managing multimedia contents illustrated in the appended drawings, in which:

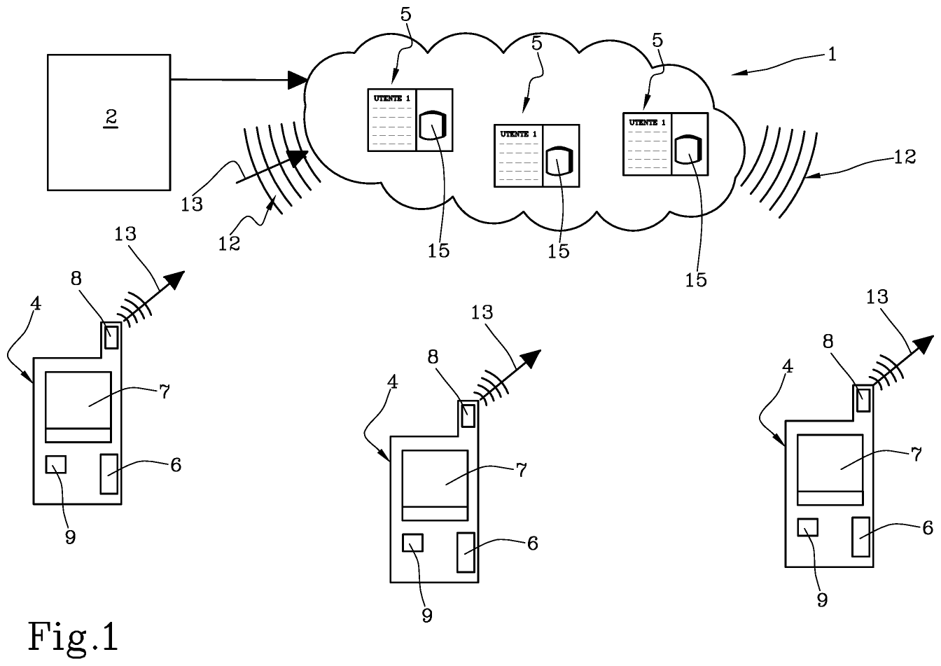

FIG. 1 shows a schematic view of a system for managing multimedia contents according to the present invention; and

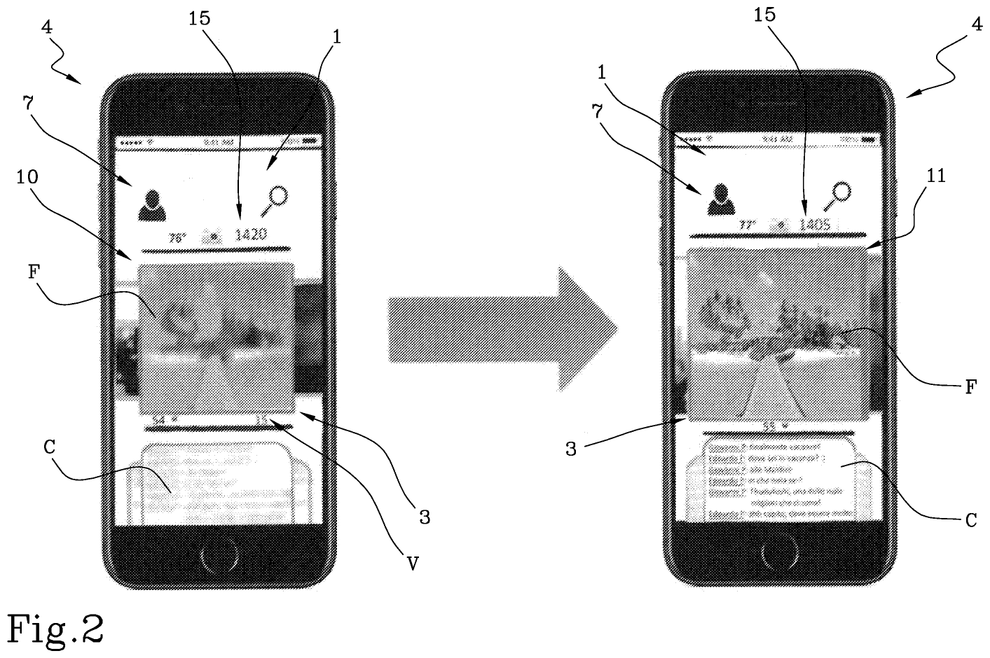

FIG. 2 shows a schematic view of a detail of the system of FIG. 1. With reference to the mentioned figures, the method and system for managing multimedia contents posted through a social network 1 according to the present invention has been generally represented. In particular, the present method is implemented through at least one computer and/or server 2 on which parts of the computer code of the social network 1 are stored.

The present invention relates to a particular system for managing multimedia contents 3 for an existing social network 1 or could be defined as a computer application or a new social network 1 in its own right. It is to be noted that the term “multimedia contents 3” means contents that comprise images and/or photos F and/or videos and/or portions of text such as written comments C or anything else not expressly mentioned here.

The method actuated by the present invention comprises a step of hosting, on one or more electronic devices 4 (e.g. smartphones as shown in the appended figures, or PCs, tablets, . . . ), a portal for said social network 1 through which a first user can access said social network 1 through their own pre-registered profile 5.

Each electronic device 4 comprises an internal electronic processing unit 6 and at least one display interface 7 (screen) configured to interact with a user. Furthermore, the electronic device 4 comprises a web connection unit 8 for connecting to the servers 2 on which at least part of the code implemented for the social network 1 is stored.

In particular, the method envisages processing a multimedia content 3, received by means of said electronic device 4, being present inside a memory 9 of the electronic device 4 itself or being present in web storage (e.g. a cloud server) connected to the electronic device 4 itself.

Said multimedia contents 3 can be processed directly by the electronic device 4 (locally) or by the processor that manages the social network 1 (online).

Furthermore, the method envisages blurring the multimedia content 3 so as to generate a blurred copy 10 of said multimedia content 3 and a clean (clear) copy 11.

Said blurred copy 10 can be obtained by overlapping an opaque electronic mask or through other known methods.

Additionally, the method envisages posting said blurred copy 10 of said multimedia content 3 on said social network 1 (in particular in the public wall section) by means of said portal for the social network 1.

In this way, said multimedia content 3 is visible to all the pre-registered users on the social network 1 that have established a connection with the first user who posted said blurred copy 10.

Such posting takes place by sending a posting signal 13 from the electronic device 4 to the web 12 or to the local network (and/or the related servers) on which said social network 1 is loaded.

Such posting signal, once received, determines the posting of the multimedia content 3 in the public wall section of the social network 1.

Following this, every pre-registered user can forward an access signal 14 containing a predetermined exchange value V in relation to the multimedia content 3 posted.

For example, if the predetermined exchange value V for said multimedia content 3 is equal to “15” (as shown in FIG. 2), the access signal must contain an exchange value V equal to “15” so as to unlock the viewing of the contents.

In this way, the method envisages receiving, via said social network 1, a predetermined exchange value V associated with said blurred copy 10 of the multimedia content 3, from a second user, having a pre-registered profile 5 in the social network 1, sent to the pre-registered profile 5 of the first user.

The exchange value V is accumulated in a value wallet 15 associated with the first user and stored in a memory unit associated with the social network 1.

In this way, the method envisages making the clean copy 11 of the multimedia content 3 visible only to said second user via said social network 1.

In other words, the multimedia content 3 in the “clean” version is only displayed for users who send the predetermined exchange value V to the first user.

In particular, the step of making said clean copy 11 of the multimedia contents 3 automatically visible takes place automatically without any further authorizations from the first user.

In detail, the step of making said clean copy 11 of the multimedia contents 3 automatically visible is solely a function of the receipt of said exchange value.

In other words, the step of making said clean copy 11 of the multimedia contents 3 automatically visible is independent from the data or identity of the second user.

It is to be noted that such “predetermined exchange value V” is an expression that can represent money, points (e.g. in a game), positive judgements (e.g. “likes” on Facebook®) or anything else not expressly mentioned herein.

At the same time, the method comprises a step of deducting said exchange value V from a value wallet 15 associated with the second user and stored in a memory unit associated with the social network 1.

In other words, the exchange value V increases the total value contained in the first user's wallet, while the total value contained in the second user's wallet decreases.

Therefore, the method comprises a step of processing the contents of the value wallets associated with the users to rank the results as a function of the accumulated exchange values.

It is to be noted that the method envisages that the wallet includes the basic exchange value V (greater than zero) at the time of registration by a user on the social network.

Additionally, it is also envisages that a user can purchase packages of predetermined exchange values V in exchange for payment of a sum of money which then accumulate in a user's wallet.

Advantageously, in this way the method allows the judgement of users who would normally not express their opinion after viewing the multimedia content 3 to be traced. In fact, according to the present invention, the multimedia content 3 is only made visible after an exchange value V has been sent.

It is to be noted that the exchange value V is pre-established by the user whose profile 5 is associated with the posted multimedia content 3.

The method can also envisage exchange value V incremental accumulation steps by users, for example, by reproducing a video and/or application and/or game to which an earning value V is preliminarily assigned. Once such videos and/or applications and/or games have been reproduced, the earning value V is accumulated in the wallet of the user who performed the reproduction.

Additionally, the method envisages that the manager of the social network makes visible (without performing any exchanges of values V and therefore without paying) only a portion of the multimedia contents (e.g. the comments) so as to stimulate interest in such content.

The present invention also relates to a system for managing multimedia contents 3 posted through a social network 1. Said system follows directly from the method described above which is incorporated in its entirety in the following. In particular, the system comprises one or more electronic processors configured to:

define, on one or more electronic devices 4 (e.g. smartphones), a portal for said social network 1 by means of which a first user can access said social network 1 via his/her own pre-registered profile 5;

processing a multimedia content 3, received by means of said electronic device 4, to blur it so as to generate a blurred copy 10 of said multimedia content 3 and a clean copy 11;

posting said blurred copy 10 of said multimedia content 3 on said social network 1 by means of said portal for the social network 1;

receiving, via said social network 1, a predetermined exchange value V associated with said blurred copy 10 of the multimedia content 3, from a second user, having a pre-registered profile 5 in the social network 1, sent to the pre-registered profile 5 of the first user;

accumulating said exchange value V in a value wallet 15 associated with the first user and stored in a memory unit associated with the social network 1;

making said clean copy 11 of the multimedia content 3 visible only to said second user via said social network 1.

It is to be noted that said one or more electronic processors are configured to deduct said exchange value V from a value wallet 15 associated with the second user and stored in a memory unit associated with the social network 1.

Furthermore, said one or more electronic processors are configured to process the contents of the value wallets associated with the users to rank the results as a function of the accumulated exchange values.

The present invention attains the set objects.

In particular, like many social applications, the present invention is based on the sharing of photos, videos or comments by the users who have pre-registered.

However, the present invention allows exchange values “earned” by the user to be managed in various ways and with which multimedia contents 3 of other people can be purchased.

The interface idea makes it very simple and intuitive. As soon as the user enters the application, they see the most recent post and if they are not interested in viewing it they can pass onto the subsequent (less recent) post. Each post will always be originally blurred so that the user cannot see the image very well (only a preview without details can be seen). What conditions the choice of purchasing the post is therefore the exchange value V (chosen by the person who posted it) and the number of views (all the people who were interested and therefore decided to proceed to purchase it). If the user is interested in seeing the image, the only thing they have to do to purchase it is to touch it. Then the post is substantially enlarged and becomes visible to the user in detail. The various posts purchased are then entered into a wall containing all the posts that the user has purchased. In the part below the application there is the comments section. It is also initially blurred (only a comment written by the person who posted the image is visible in order to give the user an idea about what the post is). The comments part will only be unlocked when the user touches the post.

Another thing that characterizes the invention is the presence of a section showing the most influential people. This section will be split into two parts: the one in which a rank of the most popular people is provided and the one in which the most powerful companies will be listed in another classification. In the part showing the classification of the most influential people, the user can decide to actuate some filters, so as to be able to see the most popular ones in a particular state or continent, a particular city or even a town.

Therefore, the purpose of the present invention is reached, i.e. highlighting the people or the pages that make people most curious, so that the people registered on it can increase their position in the ranks, also involving users that do not normally tend to express their judgement.

It should also be noted that the present invention proves to be easily realized and that the cost for implementation of the invention is not very high.

1. A method for managing multimedia contents posted through a social network and wherein said method is implemented by means of a computer, characterized in that it comprises the steps of:
hosting, on one or more electronic devices, a portal for said social network by means of which a first user can access said social network via his/her own pre-registered profile;
processing a multimedia content, received by means of said electronic device, to blur it so as to generate a blurred copy of said multimedia content and a clean copy;
posting said blurred copy of said multimedia content on said social network by means of said portal for the social network;
receiving, via said social network, a predetermined exchange value associated with said blurred copy of the multimedia content, from a second user, having a pre-registered profile in the social network, sent to the pre-registered profile of the first user;
accumulating said exchange value in a value wallet associated with the first user and stored in a memory unit associated with the social network;
automatically making said clean copy of the multimedia content visible only to said second user through said social network (4) following the receipt of said exchange value from the second user and the accumulation of said second exchange value in the value wallet associated with the first user.

2. The method according to claim 1 characterized in that said step of making said clean copy of the multimedia content automatically visible does not envisage any further authorizations from the first user.

3. The method according to claim 1 characterized in that said step of making said clean copy of the multimedia content automatically visible is a function solely of the receipt of said exchange value.

4. The method according to claim 1 characterized in that said step of making said clean copy of the multimedia content automatically visible is independent from the data or the identity of the second user.

5. The method according to claim 1, characterized in that it comprises a step of deducting said exchange value from a value wallet associated with the second user and stored in a memory unit associated with the social network.

6. The method according to claim 1, characterized in that it comprises a step of processing the contents of the value wallets associated with the users to rank the results as a function of the accumulated exchange values.

7. The method according to claim 1, characterized in that said multimedia content is an image or a video.

8. The method according to claim 1, characterized in that said exchange value is pre-established by the user whose profile is associated with the posted multimedia content.

9. A system for managing multimedia contents posted through a social network and comprising one or more electronic processors configured to:
define, on one or more electronic devices, a portal for said social network by means of which a first user can access said social network via his/her own pre-registered profile;
processing a multimedia content , received by means of said electronic device, to blur it so as to generate a blurred copy of said multimedia content and a clean copy;
posting said blurred copy of said multimedia content on said social network by means of said portal for the social network;
receiving, via said social network, a predetermined exchange value associated with said blurred copy of the multimedia content, from a second user, having a pre-registered profile in the social network, sent to the pre-registered profile of the first user;
accumulating said exchange value in a value wallet associated with the first user and stored in a memory unit associated with the social network;
automatically making said clean copy of the multimedia content visible only to said second user through said social network following the receipt of said exchange value from the second user and the accumulation of said second exchange value in the value wallet associated with the first user.

10. The system according to claim 9 characterized in that said electronic processors are configured to make said clean copy of the multimedia content automatically visible without receiving any further authorization signals from the first user.

11. The system according to claim 9 characterized in that said electronic processors are configured for making said clean copy of the multimedia content automatically visible as a function solely of the receipt of said exchange value.

12. The system according to claim 9 characterized in that said electronic processors are configured for making said clean copy of the multimedia content automatically visible regardless of the data or identity of the second user.

13. The system according to claim 9, characterized in that said one or more electronic processors are configured to deduct said exchange value from a value wallet associated with the second user and stored in a memory unit associated with the social network.

14. The system according to claim 9, characterized in that said one or more electronic processors are configured to process the contents of the value wallets associated with the users to rank the results as a function of the accumulated exchange values.

15. The system according to claim 9, characterized in that said multimedia content is an image or a video.

16. The system according to claim 9, characterized in that said exchange value is pre-established by the user whose profile is associated with the posted multimedia content.
